(19) United States
(12) Patent Application Publication
(10) Pub. No.: US 2003/0014641 A1
(43) Pub. Date: Jan. 16, 2003

(54) System for providing secure access to secure information

(76) Inventors: Brad Albert Delanghe, San Jose, CA (US); Aleksandr Mikhail Movshovich, Santa Clara, CA (US)

Correspondence Address: ALEKSANDR M. MOVSHOVICH, BRAD A. DELANGHE, 363 MACKENZIE DR., SANTA CLARA, CA, 95051, US

(21) Appl. No.: 09/905,437

(22) Filed: Jul. 16, 2001

(51) Int. Cl. H04K 1/00

(52) U.S. Cl. 713/182

(57) ABSTRACT

A method and apparatus for utilizing a random token, preferably a non-repetitive “dumb token”, for secure access by authorized users to sensitive information, specifically as a part of a system where the security algorithm and/or the password cannot be modified and/or updated during consecutive data exchange sessions. The token is generated by the Token Generator (TG) and should be presented in machine readable form to a Token Processor (TP). The TP uses the token in order to generate a secure key and an encoding sequence. The key, which may be time varying, should be sent back to the TG where it is used to generate a decoding sequence. The TP encodes the secure information using the encoding sequence and sends it to the TG, which decodes the secure information using the decoding sequence.

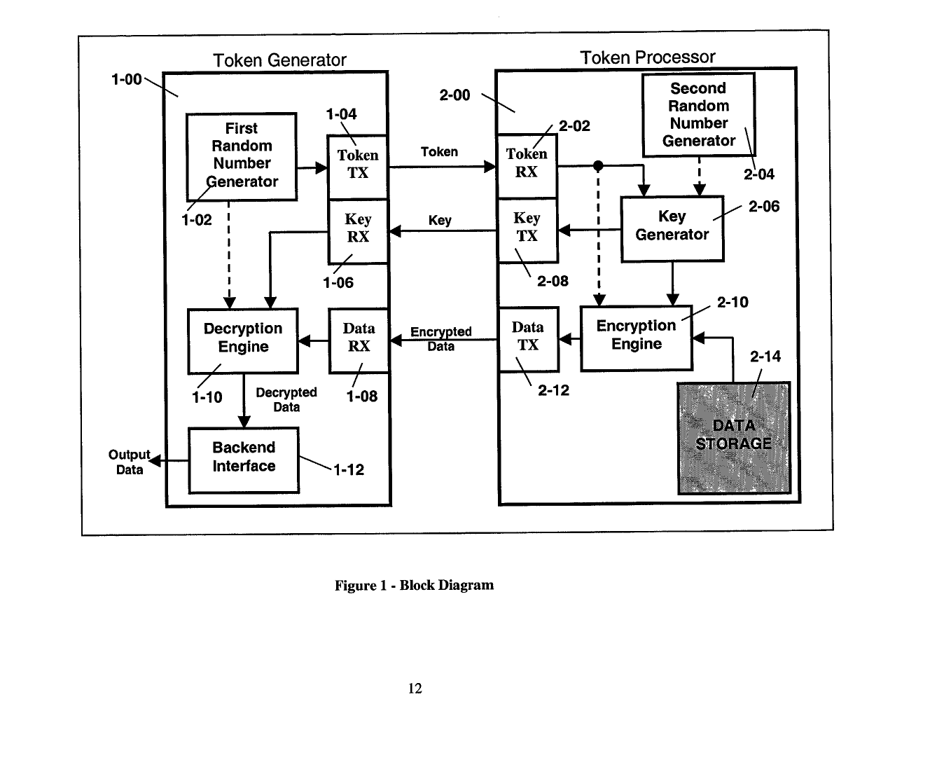

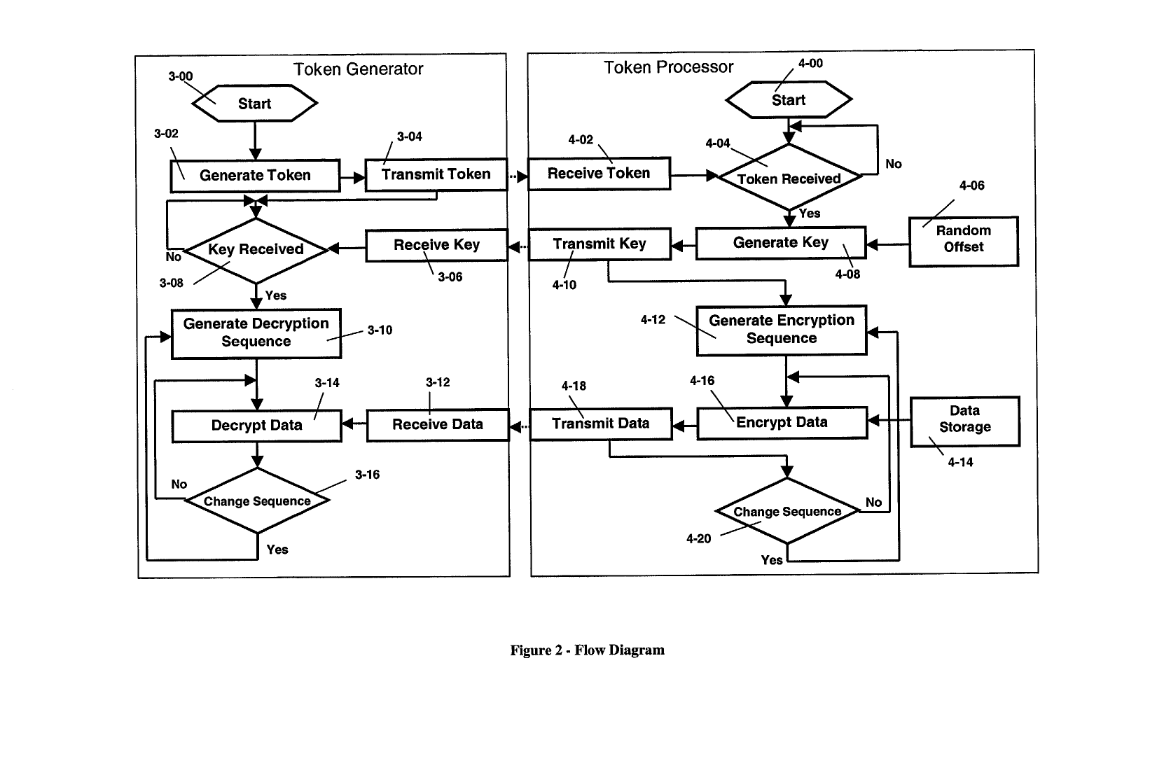

### CROSS-REFERENCE TO RELATED APPLICATIONS

For example, parent U.S. Pat. No. 5,023,908, discloses a secure communication system, wherein the end device in the possession of the individual is utilized to generate a unique, time varying and non-predictable code. The said non-predictable code is muxed with the personal identification number (PIN) and sent to the central verification computer, which verifies the validity of the PIN. This technique provides the user with high level of security in data transmission, but cannot guarantee required level of security in systems which don't have an ability to modify its PIN over time and/or adjust the technique used for muxing the said varying non-predictable code with the PIN. The fact that neither copyright protection titles, nor personal identification cards can rely on their PINs to be changed over time, by virtue of being used by not only highly trained professionals, but by the general population as well, requires new techniques to be developed in order to maintain desired level of security.

The obvious problem of the method discussed in U.S. Pat. No. 5,023,908 is linked to the fact that a “challenge” code is recommended for use in order to generate a non-predictable code, which in turn starts the sequence of events leading to successful secure data communication. The fact that the PIN (a fixed value) which has to be recognized by many (an infinite number) of end devices contrary to the central verification computer (as described in U.S. Pat. No. 5,023,908), make the data transmission vulnerable. A scenario when a set of quasi “challenge” codes is sent to the end device can be imagined. Suggested in U.S. Pat. No. 5,023,908 method of utilizing fixed algorithm of generating non-predictable code based on a “challenge” code guarantees that not only PIN value, but the data as well will be eventually exposed.

Other known methods of secure communication of the data over a not secure data transmission line also require PIN exchange. This as we know is not acceptable for applications, where multiple clients have identical PINs those PINs cannot be modified over time and all end devices must recognize all PINs of all current and all future clients (even those which at the time of the system development did not exist).

A need therefore exists for an improved means of communicating secure data over the not-secure data link. Means which don't require a PIN or other user identification code and don't rely on a central verification system such that someone tapping the line over which the code is being sent will be unable to determine the secret identification synchronization sequence and gain access to the information.

What is claimed is:

1. A system for providing secure access to secure information comprising:
a token in the possession of the token generator, where the token itself is random and non-predictable and contains no information but is used for the sole purpose of synchronization of the token processor and the token generator;
a token generator containing a transmitter used to pass the said token to a token processor;
a token processor having a reader for said token;
a token processor having the ability to generate a secure key to be used in the token generator to decipher an encrypted data sequence;
a token processor which has the ability to generate an encrypted data sequence based upon the secure key;
a token processor containing a transmitter used to pass the said secure key back to the token generator;
a token processor which has the ability to pass the encrypted data sequence for deciphering by the token generator;
a token generator which has the ability to receive the key from the token processor;
a token generator which has the ability to process the combination of the token and the key received from the token processor in order to decipher an encrypted data sequence;

2. A system as claimed in claim 1 wherein the said key is itself time-varying and non-predictable. The said key should be derived from the said token, though it is not solely dependent on it, whether the said token is time varying or constant.

3. A system as claimed in claim 1 wherein the algorithm used in the token processor to generate the encrypted data sequence is embedded inside the token processor itself, and the algorithm used in the token generator to decipher the encrypted data sequence is embedded inside the token generator itself. The algorithms used in token generator and the token processor must match each other.

5. A system as claimed in claim 1 wherein the said token can or cannot be modified by outside influences.

6. A system as claimed in claim 1 wherein the said key can or cannot be modified by outside influences.

7. A system as claimed in claim 1 wherein the algorithm used inside the token processor to generate the encrypted data sequence can or cannot be modified by outside influences.

8. A system as claimed in claim 1 wherein the algorithm used inside the token generator to decipher the encrypted data sequence can or cannot be modified by outside influences.
